(19) United States
(12) Patent Application Publication
(10) Pub. No.: US 2004/0079230 A1
(43) Pub. Date: Apr. 29, 2004

(54) Use of a textile material having a three-dimensional structure as protection against pollen for windows and doors

(76) Inventor: Andreas Schröder, Hamburg (DE)

Correspondence Address: Norris McLaughlin & Marcus, 30th Floor, 220 East 42nd Street, New York, NY, 10017, US

(21) Appl. No.: 10/380,342

(22) PCT Filed: Oct. 23, 2001
(86) PCT No.: PCT/EP01/12217

(30) Foreign Application Priority Data
Oct. 26, 2000 (DE) 100 53 226.8

(51) Int. Cl. B01D 46/00

(52) U.S. Cl. 95/273

(57) ABSTRACT

The use of spacer textiles for attachment in front of windows or doors to guard against dusty allergens such as pollen or house dust.

This invention relates to a loop-formingly knitted or woven spacer fabric which is used as a guard against the penetration of dusty, airborne allergens such as pollen and fungal spores into living and working areas by attachment in front of windows and doors over the whole area thereof.

The incidence of pollinosis (hay fever), ie the allergic reaction of the mucous membranes of the eye and of the upper and lower respiratory tracts with flower pollen and other airborne allergens, in the population has been monitored in Germany for a number of years. It was found that about 11-15% of the population is affected. The allergic reaction of a pollen allergy usually manifests itself in reddening and lacrimation of the eyes (conjunctivitis), sneezing episodes (rhinitis) and a dry cough (bronchial asthma) as early reactions. Known late reactions to pollen allergy include for example neurodermatitis or eczema. As well as the personal symptoms of sufferers, there are more far-reaching consequences such as loss of earnings or work incapacity during the pollen season or increased medical treatment costs, so that there is an immense need for a gridlike pollen guard within the meaning of the invention for attachment in front of the windows and doors of living and working areas. Further information about pollinosis is available in Ratgeber Pollenallergie, Ute Künkele, Munich 1992.

The most important properties a pollen guard for windows and doors must offer the user are: sufficient ability to air the amenities, sufficient transparency for letting light in and for looking out, and an alleviating effect with regard to pollen allergy. The most important parameters for describing a pollen guard are accordingly: air perviousness, optical transparency and filtering effect with regard to pollen.

Guard systems attached in front of windows and doors over the whole area thereof in order that the penetration of comparatively large objects such as insects into living areas may be prevented are known (=flyscreens). DE 3045723 describes for example net curtains, nets, filters or sieves for such a purpose that are attached to window or door frames by means of press studs. Owing to their relatively large mesh sizes of 1-2 mm, these do not provide adequate protection against pollen (size about 10-50 μm) and fungal spores (size about 200 μm).

Filtration means whereby air is completely cleaned of pollen, germs and spores find use in airconditioning and automobiles. The high filtering effect is achieved in DE 3904623 for example through the use of single- or else often multi-ply filter mats formed from nonwovens which, owing to their fibrous nature, make the filter stage impassable to the abovementioned allergens. To intensify the contact of the particle-laden air with the filter, the laminate of filter mats is additionally folded in a zigzag shape. However, owing to their nonexistent visual transparency, such filter mats have no utility as a protective or guard apparatus within the meaning of the present invention. In addition, such filters for airconditioning systems in automobiles give rise to substantially higher back pressures than with the use in front of the window area by the incident air movement, so that filter fleeces have to be used. A use of filter fleeces in front of windows over the whole area thereof is not suitable as a pollen guard within the meaning of this invention because of the lack of visual transparency.

A further window guard against pollen, germs and spores is disclosed for example in DE 4300422. A textile material is attached in front of the windowpane, not over the whole area thereof, but in the two wedgelike interstices and also the rectangular opening at the upper side of a window in tilt position. This form of attachment circumvents the problem of the nonexistent visual transparency of the textile material, but to completely open the window for airing purposes the textile material has to be removed, so that there is no longer any protective effect.

It is further possible to remove pollen from air flowing into an indoor amenity by means of a woven or loop-formingly knitted fabric solely by adjusting the mesh size. The sizes of most of the allergenic pollens occurring in Europe, essentially birch, grasses, goose-foot, wormwood, plantain, hazel, are in the region of 20-40 μm. The necessary mesh size for purely mechanical filtration is therefore at least 20 μm, and this is too small to provide visual transparency and air perviousness.

It is an object of the present invention to actualize the properties of air perviousness, visual transparency and adequate filtering effect with regard to pollen in one protective system. The pollen protective system or guard shall combine an adequate filtration efficiency of 70-80% with regard to pollen with adequate ventilation and adequate visual transparency. Good values of air perviousness for acceptable ventilation of a room are of the order of not less than 20 000 m³/m²/h given a differential pressure of 300 Pa. Adequate transparency within the meaning of the invention is a transmission between 20 and 100%. This object of adequate visual transparency and air perviousness coupled with adequate filtering performance is achieved through the use of a spacer textile.

Spacer textile refers to the totality of ways of producing three-dimensional textile structures from yarn material without wishing to restrict the invention which is to be protected to any one fabric-forming operation such as drawn-loop knitting, formed-loop knitting or weaving.

The loop-formingly knitted spacer fabric is to serve as an example to illustrate the production of three-dimensional loop-formingly knitted or woven structures without wishing to restrict the invention. Loop-formingly knitted spacer fabrics can be described as three-dimensional loop-formingly knitted structures. A loop-formingly knitted spacer fabric consists of two loop-formingly knitted webs which are produced from two ground threads and which are interknifted by perpendicular pile threads disposed in between the webs, and thus acquire a spacer structure. In some instances, adhesive technology is likewise used to join the outer loop-formingly knitted structures together. The two outer loop-formingly knitted structures can be fabricated independently of each other and have a wide variety of mesh sizes and different interlooping techniques, so that the most diverse possible combinations and designs are possible in the field of loop-formingly knitted spacer fabrics. The fundamentals of textile fabric-forming operations can be researched in Alfons Hofer: “Stoffe 2”, 1983, Deutsch Fachbuchverlag oder “Kettwirkpraxis”, No. 4, 1970, pages 19-20, Technologien der Kettwirkerei.

Such loop-formingly knitted spacer fabrics are frequently used, on account of their cushioning properties, in bandages or for orthopedic purposes and for seat covers, for example in the automobile industry. The use as a pollen guard in front of window areas and door openings and also for other air inlets is a new field of application and is to be protected.

The use of a loop-formingly knitted spacer fabric has the advantage over the cited approach of achieving a filtration of pollen solely by the tight mesh size that the mesh size can be increased, since the filtering effect comes about through the extended flow path and the associated longer contact with the filter material. This permits for example a higher air perviousness which enables improved airing of the amenities, since the mesh diameter does not have to be reduced to the diameter of the pollen to be filtered.

What is claim d is:

1. The use of spacer textiles for attachment in front of windows or doors to guard against dusty allergens such as pollen or house dust.
